(19) United States
(12) Patent Application Publication
(10) Pub. No.: US 2014/0255275 A1
(43) Pub. Date: Sep. 11, 2014

(54) DUAL CHAMBER LIQUID PACKAGING SYSTEM

(71) Applicant: QUIDEL CORPORATION, San Diego, CA (US)

(72) Inventors: John C. Barry, San Diego, CA (US); Peter Kroehl, Denver, CO (US)

(73) Assignee: QUIDEL CORPORATION, San Diego, CA (US)

(21) Appl. No.: 14/201,574

(22) Filed: Mar. 7, 2014

Related U.S. Application Data
(60) Provisional application No. 61/774,364, filed on Mar. 7, 2013.
(60) Provisional application No. 61/886,587, filed on Oct. 3, 2013.

(51) Int. Cl. B01L 3/00

(52) U.S. Cl. CPC B01L 3/52
USPC 422/547

(57) ABSTRACT

A packaging system with a dual chamber configuration is described. The packaging system is comprised of a primary chamber and a secondary chamber, where the primary chamber and the secondary chamber are in or capable of being in fluidic communication by a channel. The secondary chamber has an upper layer and a lower layer, wherein the lower layer is of a material that opens in response to an applied force that the upper layer is able to withstand, whereupon a fluid, preferably a liquid, in the primary chamber can be dispensed from the packaging system. In one embodiment, the packaging system is integrated with a planar cartridge having one or more chambers for processing a sample for detection of an analyte.

### CROSS-REFERENCE TO RELATED APPLICATIONS

This application claims the benefit of U.S. Provisional Application No. 61/774,364, filed Mar. 7, 2013, and of U.S. Provisional Application No. 61/886,587, filed Oct. 3, 2013. Each of the aforementioned priority documents is incorporated herein by reference in its entirety.

### TECHNICAL FIELD

The subject matter described herein relates to systems, devices, and methods for performing biological and chemical reactions. In particular, the subject matter relates to the use of burstable liquid packaging for delivery of fluids and/or reagents to a cartridge device for conducting a biological or chemical assay.

### BACKGROUND

Existing methods of storing liquid reagents used in medical diagnostics typically rely on a sterilized plastic bottle, and often require cold chain technology for shipping, transportation and storage at a final destination. This approach is feasible in most developed nations; however it poses challenges and presents higher costs for developing nations as reliable and consistent electricity for refrigeration during shipping and storage may not be available. A lack of controlled temperature during shipping or storage has the potential to expose the reagents to a temperature that renders the liquid reagent inactive or useless for clinical use.

Reagents used in diagnostics are often stored and delivered in bulk. When provided in bulk, a skilled clinical laboratory technician and precision fluid-handling equipment are often required for pipetting and aliquoting a requisite amount needed for an individual medical diagnostic test. This manual operation increase cross-contamination between samples, takes additional processing time, introduces the potential for error, and increases the cost of administering and processing a diagnostic test.

Depending on how a diagnostic system operates, liquid delivery to a diagnostic test cartridge can be done using precision pipetting, or directly through the stock liquid reagent bottles via tubing, precision pumps, and valves. Such fluidic components add increased cost and complexity to the design of the diagnostic system. Furthermore, they are often prone to contamination, failure (requiring mechanical servicing and/or replacement), and leaks.

Accordingly, additional methods of storing and delivering liquid reagents for use in conjunction with diagnostic devices are needed.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following aspects and embodiments thereof described and illustrated below are meant to be exemplary and illustrative, not limiting in scope.

In one aspect, a liquid packaging system is provided. The liquid packaging system is comprised of a primary chamber and a secondary chamber, where the primary chamber and secondary chamber are in fluidic communication by a channel. The secondary chamber has an upper layer and a lower layer, wherein the lower layer is of a material that opens in response to an applied force that the upper layer is able to withstand, whereupon a fluid in the primary chamber can be dispensed from the packaging system.

In one embodiment, the primary chamber has a larger volume than the secondary chamber.

In another embodiment, the upper layer of the secondary chamber is of a material that is more ductile than the material of the lower layer.

In still another embodiment, the material of the lower layer is a foil. In other embodiments, the material of the upper layer and/or the material of the lower layer is a laminate.

In one embodiment, the primary chamber is comprised of an upper layer and a lower layer joined about a perimeter of the chamber other than at a junction of the channel and the primary chamber.

In another embodiment, the upper layer and lower layer of the secondary chamber are joined about a perimeter of the chamber other than at a junction of the channel and the primary chamber.

In yet another embodiment, the upper and lower layers are joined to form a seal that is able to withstand the applied force.

In various embodiments, the primary chamber contains a liquid and/or the secondary chamber contains a liquid. In one embodiment, the liquid in the secondary chamber is the same as the liquid in the primary chamber.

In one embodiment, the channel has an upper layer and a lower layer, the channel upper layer and channel lower layers joined together to form a seal other than at a junction of the channel with each of the primary and secondary chambers.

In another embodiment, the primary chamber, the channel and the secondary chamber are integrally formed from the same upper layer and lower layer.

In one embodiment, the material of the lower layer is less ductile than the material of the upper layer.

In another aspect, a device comprised of a planar cartridge comprising a rigid body and a reaction chamber and a backing member attached to the rigid body, the backing member comprising a liquid packaging member is provided. The liquid packaging member is comprised of a primary chamber and a secondary chamber, where the primary chamber and the secondary chamber are in fluidic communication by a channel. The secondary chamber has an upper layer and a lower layer, wherein the lower layer is of a material that opens (tears, breaks or splits) in response to an applied force that the upper layer is able to withstand, whereupon a fluid in the primary chamber can be dispensed from the packaging member.

In one embodiment, the planar cartridge further comprises an inlet port associated with the reaction chamber, and wherein the secondary chamber of the packaging member is aligned with the inlet port such that when the lower layer opens the fluid is dispensed from the packaging member into the reaction chamber via the inlet port.

In another embodiment, the planar cartridge comprises a plurality of reaction chambers, each reaction chamber having an inlet port, and wherein the backing member comprises a plurality of packaging members.

In still another embodiment, the number of packaging members in the plurality is the same as or exceeds the number of reaction chambers in the planar cartridge.

In another embodiment, the primary chamber of the liquid packaging member contains a fluid selected from the group consisting of a water-immiscible liquid and a water-containing solution.

In one embodiment, the water-containing solution is selected from the group consisting of a water-alcohol solution, a buffer, a lysis buffer solution, and a water-salt solution.

In another embodiment, the water-immiscible liquid is an oil.

In a further embodiment, the device may further comprise a piercing member positioned within the cartridge, wherein at least one of the piercing member and the secondary chamber are movable with respect to each other such that the piercing member pierces at least a portion of the lower layer of the secondary chamber thereby permitting a fluid in the primary chamber to be dispensed from the packaging member into the cartridge.

In an embodiment, a piercing member is positioned at least partially within the inlet port. In another embodiment, a piercing member is positioned at least partially within the reaction chamber.

In a further embodiment, the piercing member is movable by an applied force between a first position and a second position, and the piercing member contacts at least a portion of the secondary chamber lower layer in the second position.

In a further embodiment, at least one of the piercing member and the secondary chamber is movable by an externally applied force.

In another aspect, a system comprised of a planar cartridge comprising a rigid body, and a piercing member; and a backing member attached to the rigid body is provided. The backing member comprises a liquid packaging member comprised of a primary chamber and a secondary chamber, the primary chamber and secondary chamber are in fluidic communication by a channel, wherein the secondary chamber has an upper layer and a lower layer. The piercing member and the secondary chamber are movable with respect to each other by an applied force such that the piercing member contacts the lower layer, thereby permitting a fluid in the primary chamber to be dispensed from the packaging member.

In an embodiment, the planar cartridge comprises an inlet port and a reaction chamber, wherein the inlet port is associated with the reaction chamber, and the secondary chamber of the packaging member is aligned with the inlet port such that when the lower layer opens the fluid is dispensed from the packaging member into the reaction chamber via the inlet port.

In a further embodiment, the planar cartridge comprises a plurality of reaction chambers, each reaction chamber having an inlet port, and wherein the backing member comprises a plurality of packaging members.

In an additional embodiment, the planar cartridge further comprises at least one piercing member positioned within the cartridge for piercing at least a portion of the secondary chamber. In an embodiment, at least one of the piercing member and the secondary chamber are movable with respect to each other such that the piercing member pierces at least a portion of the lower layer of the secondary chamber, thereby permitting a fluid in the primary chamber to be dispensed from the packaging member into the cartridge. In embodiments, at least one piercing member is positioned at least partially within the inlet port. In other embodiments, a piercing member is positioned at least partially within the reaction chamber. In further embodiments, each inlet port and/or reaction chamber includes a piercing member for interacting with an associated packaging member.

In an embodiment, at least one of the piercing member and the secondary chamber is movable by an externally applied force. In a further embodiment, the piercing member is movable by an applied force between a first position and a second position. Preferably, the piercing member contacts at least a portion of the secondary chamber lower layer in the second position. In a further embodiment, the secondary chamber lower layer is movable by an applied force such that the lower layer contacts the piercing member. In embodiments, at least one of the piercing member and the secondary chamber is movable by an externally applied force.

In a further embodiment, the piercing member is selected from a spike, a needle, and a polygon such as a pyramidal shape. In an additional embodiment, the piercing member is a cantilevered spike. In some embodiments, the cantilevered spike is integral with the planar cartridge. In embodiments, each end of the cantilevered spike is integral with the planar cartridge.

In a further aspect, a system comprising a planar cartridge, a backing member attached to the rigid body is contemplated. In embodiments, the planar cartridge comprises a rigid body and a piercing member. In further embodiments, the backing member is attached to the rigid body and the backing member comprises a liquid packaging member. The packaging member comprises a primary chamber and a secondary chamber, where the primary chamber and secondary chamber in fluidic communication by a channel. The secondary chamber has an upper layer and a lower layer. In yet other embodiments, the piercing member and the secondary chamber are movable with respect to each other by an applied force such that the piercing member contacts the lower layer, thereby permitting a fluid in the primary chamber to be dispensed from the packaging member.

In embodiments, the planar cartridge of the system comprises an inlet port and a reaction chamber, wherein the inlet port is associated with the reaction chamber, and wherein the secondary chamber of the packaging member is aligned with the inlet port such that when the lower layer opens the fluid is dispensed from the packaging member into the reaction chamber via the inlet port. In further embodiments, the planar cartridge comprises a plurality of reaction chambers, each reaction chamber having an inlet port, and wherein the backing member comprises a plurality of packaging members.

In embodiments, each inlet port includes a piercing member for piercing the lower layer of the associated secondary chamber. In further embodiments, at least one of the piercing member and the secondary chamber is movable by an externally applied force.

In an embodiment, the system further comprises an actuator for actuating the secondary chamber thereby moving at least a portion of the lower layer of the secondary chamber into contact with the piercing member. In a further embodiment, the actuator applies an external force to the secondary chamber. In a further embodiment, the system further comprises an actuator for actuating the piercing member thereby moving the piercing member into contact with at least a portion of the lower layer of the secondary chamber. In another embodiment, the actuator applies an external force to the piercing member. In an additional embodiment, the system includes both an actuator for actuating the secondary chamber and an actuator for actuating the piercing member.

In a further embodiment, the piercing member is selected from a spike, a needle, and a polygon such as a pyramidal shape. In an additional embodiment, the piercing member is a cantilevered spike. In some embodiments, the cantilevered spike is integral with the planar cartridge. In embodiments, each end of the cantilevered spike is integral with the planar cartridge. In further embodiments, the piercing member includes a feature or modification to enhance the piercing ability of the piercing member. In an embodiment, the piercing member includes one or more (at least one) split or slit to form two or more spikes or sharpened areas at the end of the piercing member that faces the secondary chamber lower layer.

Additional embodiments of the present device and methods, and the like, will be apparent from the following description, drawings, examples, and claims. As can be appreciated from the foregoing and following description, each and every feature described herein, and each and every combination of two or more of such features, is included within the scope of the present disclosure provided that the features included in such a combination are not mutually inconsistent. In addition, any feature or combination of features may be specifically excluded from any embodiment of the present invention. Additional aspects and advantages of the present invention are set forth in the following description and claims, particularly when considered in conjunction with the accompanying examples and drawings.

### BRIEF DESCRIPTION OF THE DRAWINGS

FIGS. 1A-1C are, respectively, a top perspective view, a cross-sectional perspective view and a cross-sectional view of an embodiment of a packaging member;

FIGS. 2A-2C show a packaging member integrated with a cartridge, where FIG. 2A shows a front view of the cartridge, FIG. 2B shows a back view of the cartridge with attached packaging members, and FIG. 2C shows a back view of the cartridge without the backing member and packaging members;

FIGS. 3A-3C illustrate interaction of the packaging member and the cartridge to dispense fluid in the packaging member into the cartridge; and

FIGS. 4A-4B are cross-sectional diagrams of an integrated packaging member and a rigid, disposable cartridge, with the packaging member attached to the cartridge with the secondary chamber positioned to deliver its contents into the chamber.

FIGS. 5A-5B are cross-sectional diagrams of embodiments of an integrated packaging member and a rigid, disposable cartridge including a piercing member.

FIGS. 5C-5E are cross-sectional diagrams of embodiments of a cartridge and exemplary piercing member configurations.

FIGS. 6A-6F illustrate some exemplary piercing members.

FIGS. 7A-7B illustrate piercing members with some exemplary modifications or sharpening features.

### DETAILED DESCRIPTION

### Definitions

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 μm to 8 μm is stated, it is intended that 2 μm, 3 μm, 4 μm, 5 μm, 6 μm, and 7 μm are also explicitly disclosed, as well as the range of values greater than or equal to 1 μm and the range of values less than or equal to 8 μm.

The singular forms “a,” “an,” and “the” include plural referents unless the context clearly dictates otherwise. Thus, for example, reference to a “polymer” includes a single polymer as well as two or more of the same or different polymers, reference to an “excipient” includes a single excipient as well as two or more of the same or different excipients, and the like.

A “liquid reagent”, as the term is used herein, refers to any liquid contained within any of the storage compartments of the cartridge device as described herein, including aqueous, nonaqueous, and water-immiscible liquids.

A “reagent solution” typically refers to an aqueous solution. The “reagent” in a reagent solution may be a chemical or biological substance that causes a chemical change to a sample component, or it may be simply a buffering agent, a salt, or a solvent.

A region within a cartridge or device, such as a cavity, chamber, or channel, is “in communication with” or “in fluid communication with” another such region if there is a continuous path between the two regions, such that liquid could be (but not necessary is) transferred between them. In some cases, a valve or seal must be opened before such transfer occurs.

A storage compartment or chamber is “associated with” a respective chamber or channel when the two are connected via one or more conduits, channels, and/or ports, such that the contents of the storage compartment can be transferred to the chamber or channel. Typically, seals or valves are provided to prevent premature transfer of contents.

### System and Device

The present invention relates to systems, devices, and methods for performing biological and chemical reactions. In particular, the present invention relates to a liquid packaging system for delivery of reagents to a device for use in conducting biological and chemical assays.

In some embodiments, the present invention provides a disposable liquid packaging module that stores liquids, both aqueous and nonaqueous, in sealed compartments, chambers or “blister packages” that are barriers to vapor, oxygen, and UV, and that can be crushed, torn, opened, or broken by an applied force, to deliver the contained liquid.

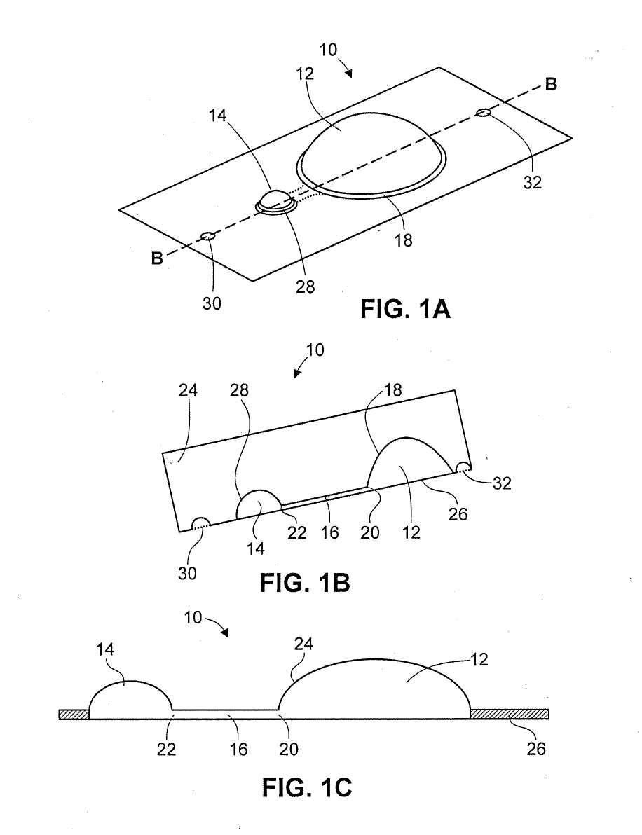

An embodiment of a packaging system is shown in FIGS. 1A-1C. Packaging member 10 is comprised of a first or primary chamber or compartment (these terms when used with regard to the packaging member are interchangeable) 12 and a second or secondary chamber or compartment 14. As seen best in FIGS. 1B-1C, the primary and secondary chambers are in fluid communication by a channel 16. The perimeter, such as perimeter 18 of the primary chamber, the chamber is sealed with a fluid-tight seal, as are known in the art. A junction 20 at the point where channel 16 intersects primary chamber 12 and/or a junction 22 at the point where channel 16 intersects secondary chamber 14 remain unsealed or include a seal that is broken upon application of force to either or both of the primary or secondary chambers.

In one embodiment, the primary chamber and secondary chambers have a capacity or volume, and the capacity of the two chambers is different. In one embodiment, the secondary chamber has a smaller capacity than the primary chamber. In one embodiment, the secondary chamber has a volume or capacity that is 10 times less than that of the primary chamber, preferably 20 times, 50 times, or 100 times less than the primary chamber.

As can be seen in FIGS. 1B-1C, the primary and secondary chambers are formed of an upper layer 24 and a lower layer 26. In one embodiment, the lower layer in each of the primary and secondary chambers is comprised of the same material. The material that forms the lower layer in the secondary chamber (the chamber with the smaller volume) is able to tear, break or split upon application of an externally applied force. The material that forms the upper layer in the secondary chamber is able to withstand the applied external force in that it does not tear, break or split when the force is applied to the secondary chamber. Typically, the material forming the upper layer is more ductile or flexible than the material forming the lower layer.

As depicted in FIGS. 1A-1C, the upper layer 24 of the packaging system is a single contiguous layer of a material that is joined with the lower layer 26, which is also a single contiguous layer of a material, and the upper and lower layers are sealed at a perimeter 18 to form the primary chamber and at another perimeter 28 to form the secondary chamber.

The packaging member can optionally include one or more alignment members, such as alignment holes 30, 32 seen in FIGS. 1A-1B. The alignment member is configured to mate with a corresponding member on a cartridge, to ensure alignment of the secondary chamber of the packaging system with the inlet port on the cartridge.

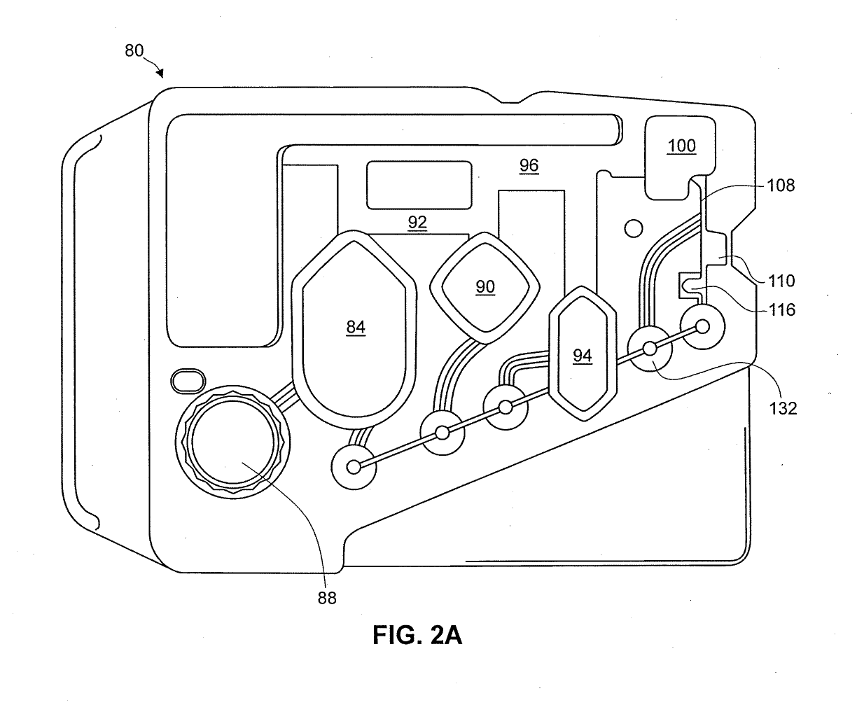

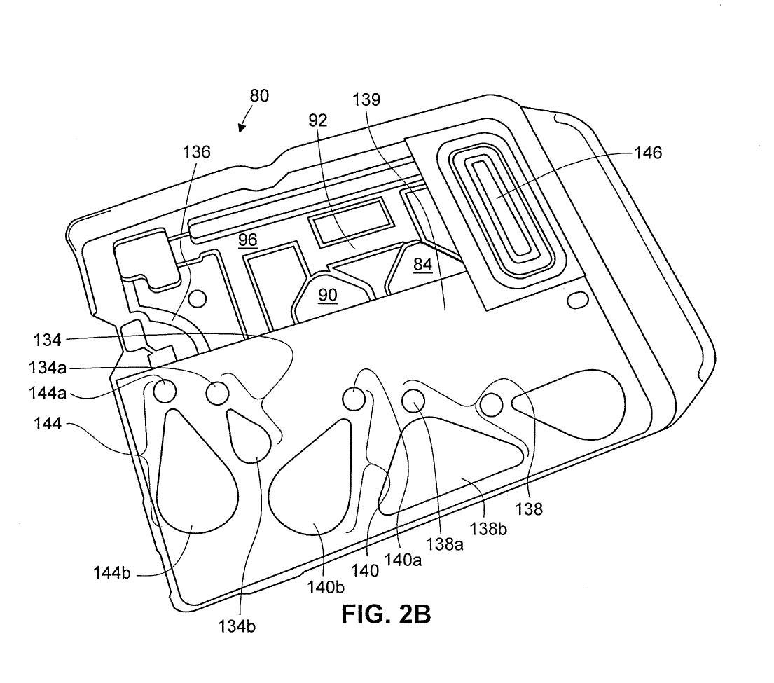

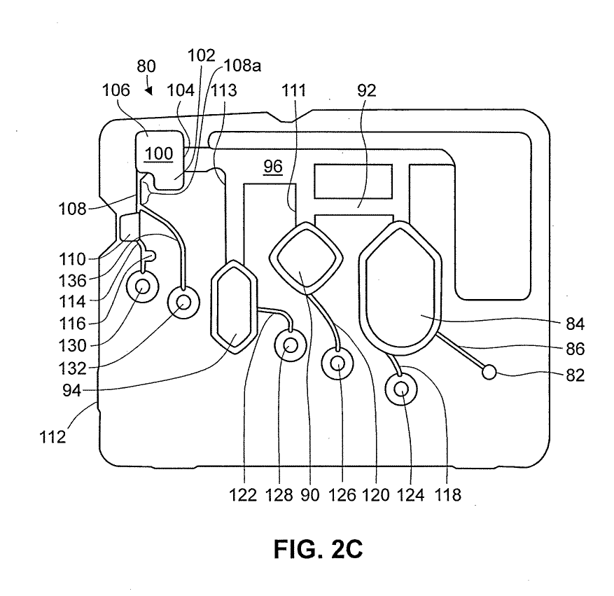

As will now be described, the dual chamber packaging system provides for controlled fluid delivery of the liquid contents in the packaging system into a device, such as an assay cartridge. An example is shown in FIGS. 2A-2C, where a cartridge with several packaging systems integrated onto the back of the cartridge is shown. Cartridge 80 is shown in a front view in FIG. 2A and is made of a rigid material in which a plurality of cavities and conduits can be formed. A back view of the cartridge is seen in FIG. 20, where the back view is shown without the packaging systems attached so that the various cavities, ports and conduits can be seen. FIG. 2B shows the back view of the cartridge, with a back wall comprising a plurality of packaging systems attached to the cartridge.

With initial reference to FIGS. 2A and 2C, a sample entry port 82 permits a user to introduce a sample into a first cavity or chamber 84 of the cartridge. Entry port 82 is in fluid connection with first chamber 84 by a conduit 86. As seen in FIG. 2A, entry port 82 may have a cap 88 to open and close the entry port from the external environment. Cartridge 80 additionally comprises a second chamber 90 in fluid communication with first chamber 84 via channel or conduit 92. A third chamber 94 is in fluid communication with the second chamber 90 via a channel 96. Channel 96 is also in fluid communication with a fourth chamber 100, which has a lower portion 102 positioned below the opening 104 where channel 96 terminates into chamber 100 and an upper portion 106 above opening 104. Chamber 100 is in fluid communication via conduit 108 with a fifth chamber 110. Fifth chamber is also referred to as a processing chamber, and is situated along an edge 112 of cartridge 80 for optical inspection of the contents in chamber 110.

Chamber 100 is a dual purpose chamber. Lower portion 102 is dimensioned to receive and contain excess fluid (overfill) from processing chamber 110. As described below, in some embodiments a precise amount of fluid in processing chamber is desired for reaction control. A precise amount of fluid is provided by overfilling chamber 110 so that fluid enters conduit 108. When an immiscible fluid is introduced into the cartridge also as described below, the overfill processing chamber fluid in conduit 108 is displaced into the lower portion 102 of chamber 100. Chamber 100 in its upper portion 106 provides an air gap for pressure equalization and for movement of the particle-analyte complexes into the air gap to permit removal of volatile solvents or other liquid reagents from the complexes prior to transfer of the complexes into the processing chamber.

Conduit 108 comprises a narrow portion or region of construction 108a in the flow path processing chamber 110 and its adjacent chamber. The constriction region provides fluid control as the chambers are filled with fluid from the storage compartments and required the particle-analyte complexes to separate somewhat from adjacent particle-analyte complexes to assist in removal of fluid from the plurality of particles as the plurality is moved through the conduit.

Device 80 also comprises a first dividing wall 111 that has a first height and a second dividing wall 113 that has a second height greater than the first dividing wall. This feature also provides for control of fluids during filling of the chambers and conduits of the device, and minimizes undesired mixing of fluids in each respective chamber of the device.

A conduit 114 is in communication with processing chamber 110, and in this embodiment conduit 114 includes a holding chamber 116. Holding chamber 116 is dimensioned and positioned to receive and contain the plurality of particles. For example, detection or amplification of an analyte in processing chamber 110 may proceed optimally in the absence of the plurality of particles. In this case, the analyte can be eluted from the particles and the particles moved by the externally applied force into the holding chamber. The analyte to be processed and/or detected remains in the processing chamber.

Each chamber 84, 90, and 94 has an associated reagent conduit, such as conduits 118, 120 and 122, respectively. Conduit 114 serves as reagent conduit for the processing chamber 110. Each of conduits 114, 118, 120 and 122 is associated with an opening, seen best in FIG. 2C, as openings 124, 126, 128 and 130.

Each opening is associated with a packaging member, seen best in FIG. 2B, that contains a liquid or liquid reagent that can be introduced via an opening into a respective cartridge chamber. With reference to FIG. 2B, the back side of cartridge 80 is shown, where a back wall member 139 is placed over the rigid cartridge body, enclosing the cavities and conduits formed therein. The wall member comprises a plurality of packaging systems, preferably integrally formed with the wall member, wherein each packaging system contains a fluid that is dispensed into its associated cartridge chamber during use of the cartridge.

By way of example, a packaging member 134 is comprised of a primary chamber 134a and a secondary chamber 134b. The primary chamber 134a is filled with an immiscible fluid and is aligned with opening 132 and its associated conduit 136. When secondary chamber 134b is opened by application of an external force applied to the secondary chamber, the lower layer (not visible in FIG. 2B) of the secondary chamber tears, breaks or splits (collectively, these actions are referred to herein as the lower layer “opens” or as the lower layer “opening”). The immiscible fluid in the primary chamber 134b flows from the primary chamber into the channel connecting the primary chamber and secondary chamber, to dispense the fluid in the packaging system via opening 132 into conduit 136 of the cartridge and into chamber 100. In a preferred embodiment, the secondary chamber is placed directly over the opening to a conduit in a cartridge, directly over an opening to a chamber in a cartridge. Depending on the capacity of the primary chamber and the volume of immiscible fluid placed therein, the fluid may flow via opening 104 into conduit 96 and, if desired, into conduit 92.

Packaging member 138 is comprised of a primary chamber 138a and a secondary chamber 138b. The primary chamber 138a is filled, for example, with a buffer or wash solution that is introduced via opening 126 and conduit 120 that holds sufficient solution to fill conduit 120, chamber 90 and conduit 92.

Packaging member 140 is comprised of a primary chamber 140a and a secondary chamber 140b. Secondary chamber 140b is in fluid communication via opening 128 and conduit 122 with chamber 94.

A packaging member 144 is comprised of a primary chamber 144a and a secondary chamber 144b. Primary chamber 144a is filled with a fluid for use in the processing chamber 110, and is provided to the processing chamber via port 130 and conduit 114. Secondary chamber 144b is aligned for fluid communication with port 130, so that when the secondary chamber is opened, fluid can flow from the packaging member into the port, conduit, and associated cartridge chamber.

Wall member 139 may also comprises an inflatable member, such as member 146. Inflatable member 146 is positioned over an air vent or an air collection zone in the cartridge, and can inflate as needed to accommodate air from the chambers and channels in the cartridge that is displaced when fluid from the packaging members is dispensed into the cartridge.

In one embodiment, the primary and secondary chambers in the packaging system are hemispherical in shape, and are comprised of a vapor, oxygen, and UV barrier laminate material. A predetermined volume of a liquid is precisely aliquoted into the primary and or secondary chamber during manufacture of the packaging system. A perimeter seal is created using one of many available heat sealing technologies (e.g., resistive, laser, radio frequency, ultrasonic). The packaging system is then integrated with a rigid plastic cartridge. During uses, the secondary chamber of the packaging system is burst open, by applying a force to the chamber, as will now be described.

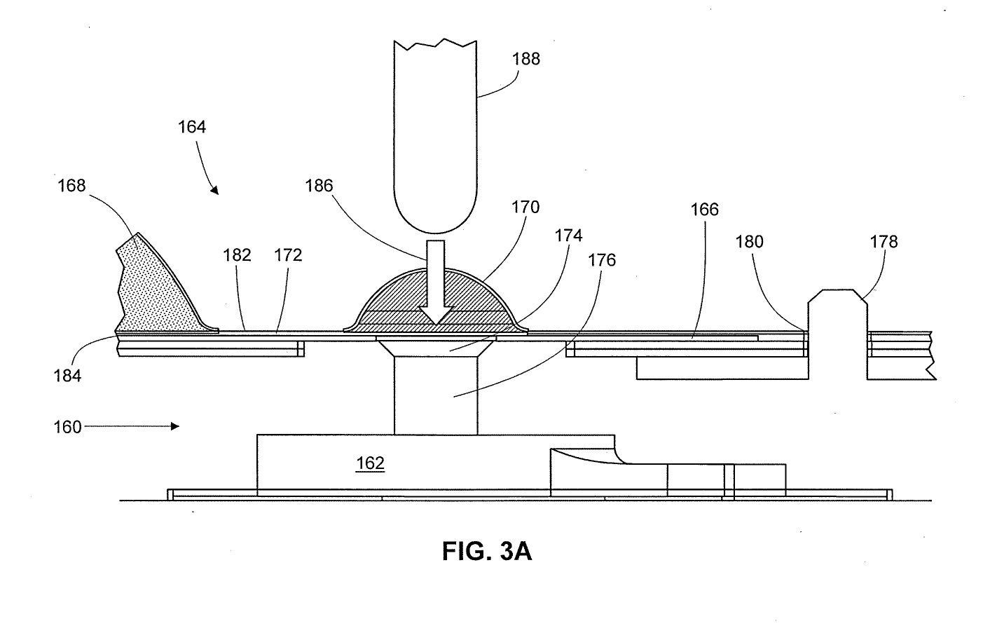

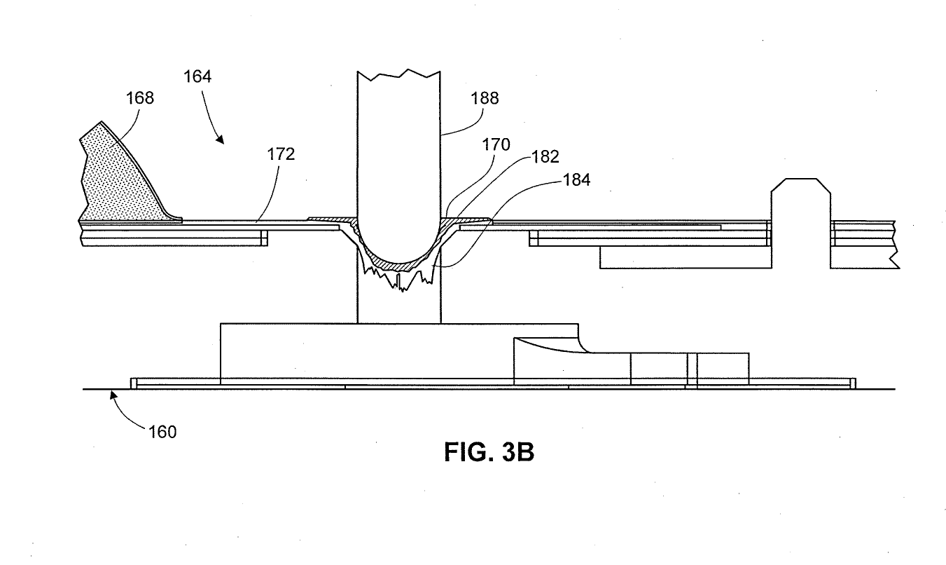

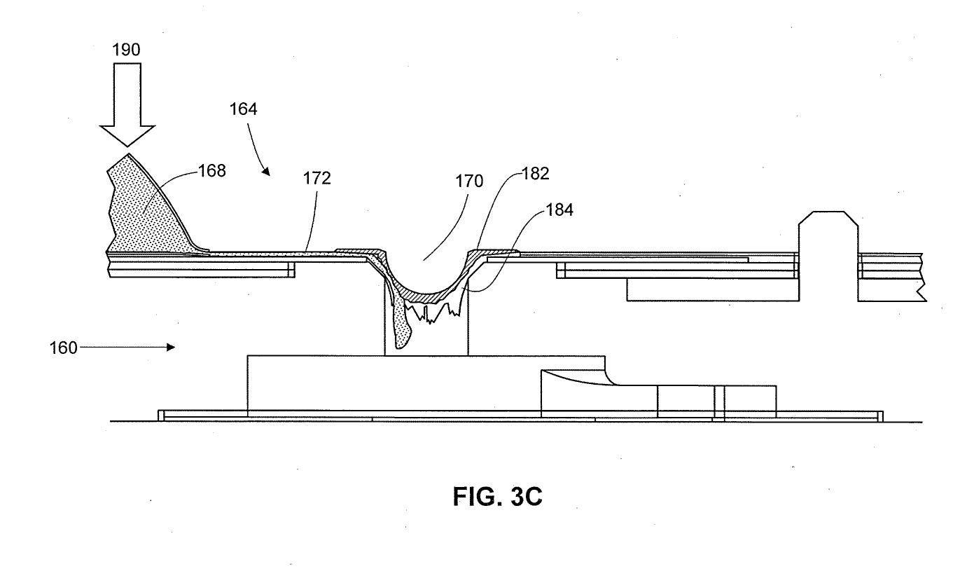

FIGS. 3A-3C illustrate an embodiment of an interaction of the packaging member and the cartridge to dispense fluid in the packaging member into the cartridge. In this embodiment, a cartridge 160 comprises a chamber 162 in fluid connection with a packaging system 164 integrated with the back wall 166 of the cartridge. The packaging system is comprised of a primary chamber 168, only partially visible in FIGS. 3A-3C, and a secondary chamber 170. The primary chamber and secondary chamber are in fluid communication by a channel 172. The secondary chamber is positioned for fluid communication with an inlet port 174 that is in communication with chamber 162 via a conduit 176. It will be appreciated that the inlet port 174 may communicate directly with the chamber 162. An optional alignment member, such as alignment pin 178, on the cartridge engages an optional alignment member, such as opening 180, on the packaging system, ensures that the secondary chamber is correctly positioned for fluid communication with the inlet port to the cartridge chamber.

The primary chamber 168 contains a liquid. In some embodiments, the primary chamber contains both a liquid and air or other gas (nitrogen, argon). As described in U.S. Patent Application Publication No. 2012-0117811, which is incorporated by reference herein in its entirety, a gas present in the primary chamber facilitates release of the contents from the primary chamber. The secondary chamber 170 typically contains a gas (air, nitrogen, argon, etc.), but can contain a liquid reagent if desired. As seen in FIGS. 3A-3C, the packaging system is made of an upper layer 182 of a material and a lower layer 184 of a material. As will be appreciated from the description of FIGS. 3B-3C, the material forming the upper layer is one that is able to flex and move with a force, indicated by arrow 186, applied by an external means 188 to the secondary chamber. The material forming the lower layer 184 opens or bursts upon application of force 186. Generally, the material of the upper layer is flexible or ductile, and the material of the lower layer is brittle, breakable or rupturable. A skilled artisan in packaging materials is able to appropriately select suitable materials for each layer, and some examples are provided below.

As seen in FIG. 3B, lower layer 184 in response to the applied force tears open, ruptures, or bursts. Upper layer 182 flexes and moves with the applied force, remaining intact in response to the applied force. Accordingly, breakage of the lower layer in the secondary chamber of the packaging system creates a fluid connection between the packaging system and the chamber in the cartridge. As seen in FIG. 3C, a pressure 190 applied externally to the primary chamber 168 of the packaging system forces the contents of the primary chamber into channel 172, into the inlet port 174 that is in communication with chamber 162 via conduit 176.

As can be appreciated, by providing a dual chamber packaging system where an initial chamber in the system is opened to create a fluid connection with an attached device, and a liquid storage (primary) chamber in the system is manipulated to release its contents into the created fluid connection provides for controlled delivery of the liquid into the device. The feature of a packaging system wherein at least one of the chambers is fabricated from materials that respond differently to an applied force, where one material opens in response to the force and the other material flexes and remains intact in response to the force, is contemplated. Manipulation of the primary storage chamber that contains the liquid to be delivered to a device is optional. When done to facilitate complete release of the contents, the manipulation of the primary storage chamber may be achieved by an externally applied force, wherein the force applied to the primary storage chamber is less than the force required to break, tear or split the lower layer of material (and upper layer of material) from which the primary storage chamber is fabricated. In embodiments where the lower layer of material that forms the primary storage chamber and the secondary storage chamber is the same, the force applied to the secondary storage chamber is higher than the force applied to the primary storage chamber, so that the lower layer in the primary storage chamber remains intact whereas the lower layer in the secondary storage chamber opens.

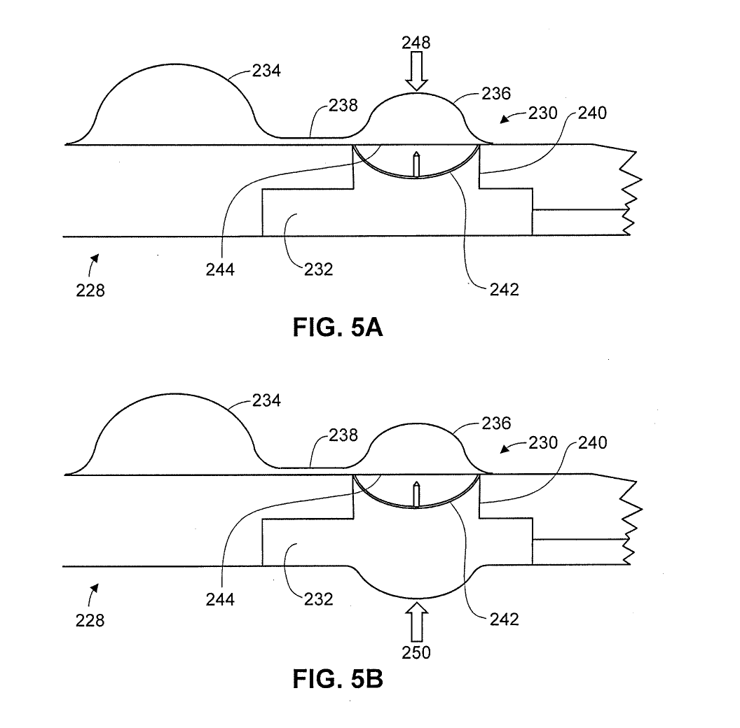

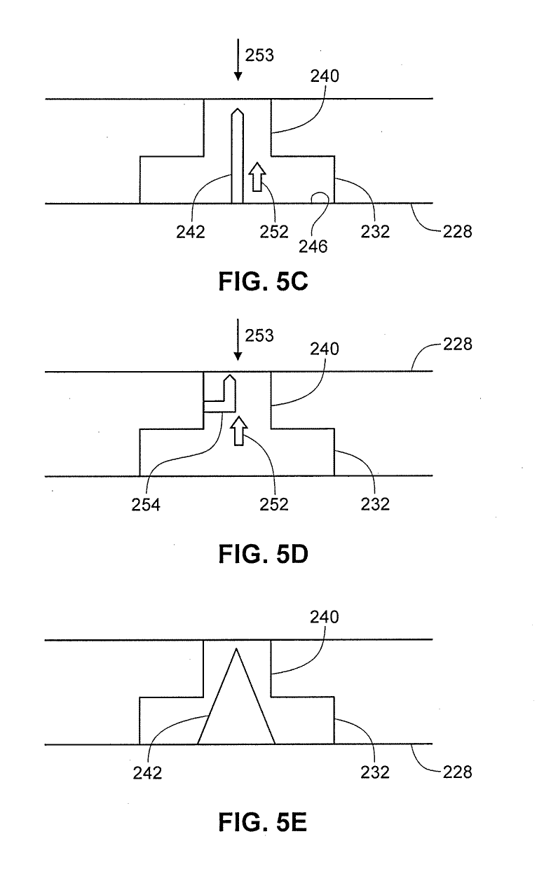

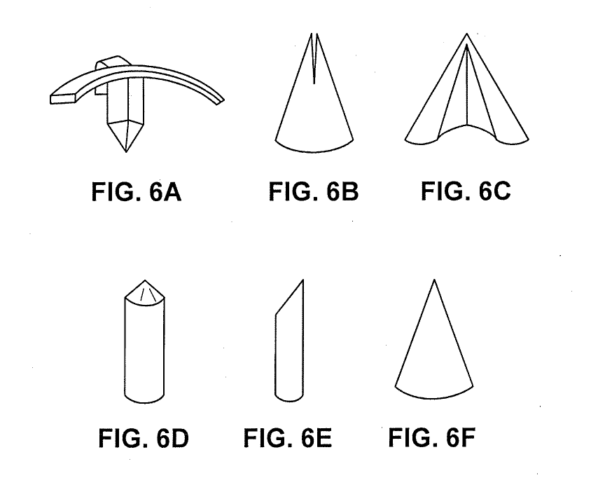

FIGS. 5A-5B illustrate further embodiments of an interaction of a packaging member and the cartridge to dispense fluid in the packaging member into the cartridge. As above, the packaging system 230 is integrated with the cartridge 228 such that a chamber 232 of the cartridge 228 being in fluid connection with the packaging system 230. The packaging system or member 230 is comprised of a primary chamber 234 and a secondary chamber 236 that are in fluid communication by a channel 238. The secondary chamber is positioned for fluid communication with an inlet port 240 in the cartridge 228 that is in fluid communication with chamber 232 such as a reaction chamber. The cartridge 228 further includes a piercing member 242 for opening, lancing, piercing, puncturing, rupturing, breaking or tearing a bottom layer 244 of the secondary chamber 236. The material forming the lower layer 244 opens upon contact with the piercing member 242 or upon force applied from the piercing member 242. Breakage of the lower layer in the secondary chamber creates a fluid connection between the packaging system and the chamber in the cartridge. The piercing member may be any suitable shape or size for opening, lancing, piercing, puncturing, rupturing, breaking or tearing at least a portion of the secondary chamber 236. In embodiments, the piercing member has a sharp end or surface that faces the secondary chamber. In one embodiment, the piercing member is integral with, attached to or affixed within the inlet port 240 (see FIGS. 5A and 5B). In other embodiments, the piercing member is integral with, attached to or affixed to the cartridge at a position other than within the inlet port. As a non-limiting example, the piercing member may further be integral with, attached to or affixed to the wall 246 of the cartridge opposing the inlet port (see FIGS. 5C and 5E). In other embodiments, the piercing member is attached to at least a portion of the chamber 232 associated with the inlet port. In further embodiments, at least two or a plurality of piercing members are integral with, attached to or affixed to the cartridge at one or more areas. As seen in FIGS. 5C-5D, an applied force in the direction of arrow 252 moves the piercing member with respect to the secondary chamber (not shown). Alternatively, an applied force on the secondary chamber and/or the piercing member moves the secondary chamber and/or the piercing member with respect to each other. FIG. 5E shows a further embodiment of a piercing member 242 attached to or affixed to the wall of the cartridge or a chamber 232 in the cartridge 228. In this embodiment, the piercing member has a pyramidal shape. FIGS. 6A-6F show further embodiments of a piercing member positioned in the cartridge or chamber.

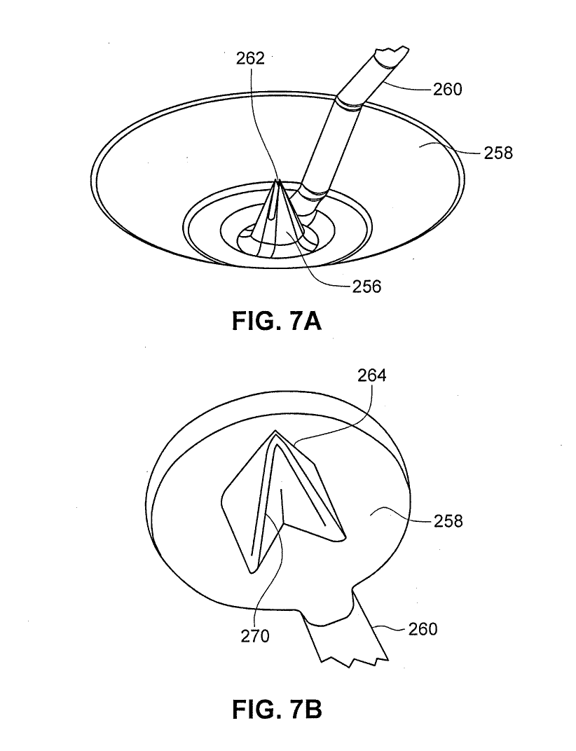

In some embodiments, the piercing member includes a feature or modification to make the piercing member sharper or to enhance a sharpness of the piercing member. FIG. 7A shows a piercing member 256 positioned within a chamber 258. The chamber 258 includes an associated conduit or channel 260. In this embodiment, the piercing member has a pyramidal shape where a top portion of the piercing member may be split and have two or more sharp portions or spikes 262. In the embodiment shown in FIG. 7A, the piercing member includes a single slit that splits the apex of the pyramid into two sharp portions. The slit as shown in FIG. 7A extends about halfway along the length of the pyramid. In other embodiments, the slit extends about ¼, about ⅓, about ½, or about ¾ through the piercing member. In embodiments, at least a portion of the apex of the pyramid is the split portion. It will be appreciated that the slit(s) may extend through any length of the piercing member. In other embodiments, piercing members having other shapes (e.g. a pin or a needle) may have one or more slits, splits, or spikes. It will be appreciated that a pyramidal shaped piercing member may have any suitable number of sides. It will further be appreciated that the base of the pyramidal shaped piercing member may be any suitable size based on the size and shape of the chamber or chamber area where it is positioned.

In a further embodiment shown in FIG. 7B, the piercing member 264 includes one or more cut-outs or grooves 270 along one or more sides of the piercing member.

In other embodiments, the piercing member is movable within the cartridge in response to an applied force. In embodiments, the applied force is an internally applied force or an externally applied force. In an embodiment, the piercing member is movable between at least a first position and a second position where the piercing member is at least partially in contact with the secondary chamber. In this embodiment, the piercing member is positioned within the cartridge and affixed or attached in a manner suitable for movement between the first and second positions. In even further embodiments, only a portion of the piercing member is movable within the cartridge. In this embodiment, the piercing member is generally attached or integral with the cartridge at one or more positions. A portion of the piercing member is movable in response to an applied force into contact with the secondary chamber.

Preferably, the piercing member has a sharp or pointed distal end for contacting the secondary chamber. In non-limiting embodiments, the piercing member has a slanted, pointed, or chevron shaped distal end. In further embodiments, the piercing member is a pin, needle or a spike. It will be appreciated that the piercing member may have any size or shape suitable for piercing at least a portion of the secondary reservoir. However, care should be taken so that fluid in the secondary reservoir may suitably flow into the cartridge. FIGS. 6A-6F show some exemplary and suitable, but not limiting, shapes for the piercing member. The piercing member may be formed of a similar or different material than the cartridge. In an embodiment, the piercing member is attached or affixed to the cartridge using a cantilever arm (FIG. 5D). As shown in this embodiment, the cantilever arm 254 is attached or affixed to the inlet port 240. It will be appreciated that the cantilever arm could be attached or affixed at a different point within the cartridge. An applied force in the direction of arrow 252 moves the piercing member 254 with respect to the secondary chamber (not shown). In another embodiment, an applied force in the direction of arrow 253 moves the secondary chamber with respect to the piercing member. Alternatively, an applied force on the secondary chamber and/or the piercing member moves the secondary chamber and/or the piercing member with respect to each other. It will be appreciated the piercing member may be a cantilever type having more than one attachment point (see FIGS. 5A-5B). An exemplary piercing member having three attachment points is shown in FIG. 6A.

As seen in FIG. 5A, the secondary chamber 236 may be actuated in the direction of arrow 248 to move at least a portion of the lower layer into contact with the piercing member. In embodiments, the system or device includes an actuator for actuating the secondary chamber. In embodiments, the secondary chamber is movable by an externally applied force. In response to force or pressure from the actuator, the lower layer in the secondary chamber flexes at least partially into the inlet port and into contact with the piercing member. Contact of the secondary chamber lower layer with the piercing member causes the lower layer to open, be lanced, be pierced, be punctured, rupture, break or tear. As above, the primary chamber may then be manipulated to deliver liquid to the cartridge.

In another embodiment as shown in FIG. 5B, the piercing member 242 is actuated to contact the secondary chamber lower layer 244. In this embodiment, the cartridge may include a flexible wall allowing force applied along the arrow indicated at 250 to move the piercing member into contact with the lower layer. In embodiments, the piercing member is movable by an externally applied force. In another embodiment, not shown, the actuator may be positioned within the cartridge.

It will be appreciated that actuation or movement of the secondary chamber and/or the piercing member may be in response to an internally applied or an externally applied force. FIGS. 5A-5D each shows an externally applied force at arrows 248, 250, 252, and 253, respectively. In further embodiments, the piercing member and the secondary chamber are movable with respect to each other. One or both of the piercing member and the secondary chamber may be movable with respect to each other.

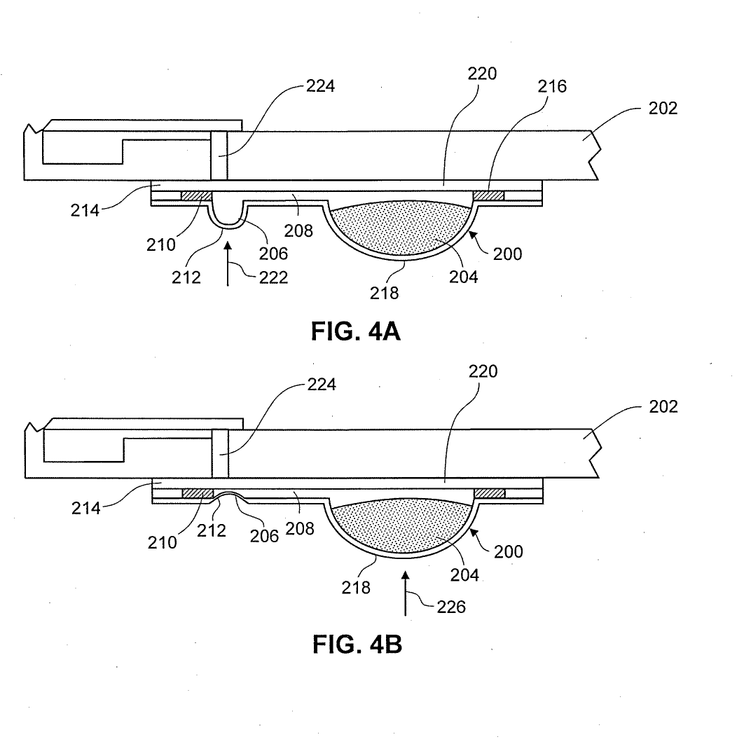

FIGS. 4A-4B are cross-sectional diagrams of an integrated packaging member 200 and a rigid cartridge 202. The packaging member in this embodiment serves a dual purpose as the back wall of the cartridge and a packaging member. It will be appreciated that the cartridge may have a back wall in addition to one or more attached packaging members. Packaging member 200 is comprised of a primary chamber 204 and a secondary chamber 206. The two chambers are connected by a channel 208. A perimeter seal 210 secures an upper layer 212 to a lower layer 214 to form the secondary chamber. A perimeter seal 216 secures an upper layer 218 to a lower layer 220 to form the primary chamber 204. In one embodiment, upper layer 212 and upper layer 218 are integral and formed of the same piece of material. In one embodiment, lower layer 214 and lower layer 220 are integral and formed of the same piece of material. As can be seen, in one embodiment, the perimeter seal about each chamber is incomplete in that a gap in the perimeter seal is present at the junction of channel 208 with each chamber. It will be appreciated that the gap at one or both of the junctions can be closed with a seal that is disrupted by an external force to effect movement of fluid between the chambers of the packaging member.

To dispense the contents of the packaging member into the cartridge, a force, indicated in FIG. 4A by arrow 222, is applied to the secondary chamber that is aligned with an input port 224 to the cartridge. The applied force causes the lower layer 214 of the secondary chamber to open. Upper layer 212 remains intact and is not mechanically disrupted by the applied force, but flexes and moves with the force, as can be seen in FIG. 4B. Opening of the lower layer of the secondary chamber creates a fluid connection between the packaging system and the cartridge. If needed, a force, indicated by arrow 226, is applied to the primary chamber, to dispense the chamber contents through the created fluid connection and into the cartridge.

As can be appreciated from the foregoing, the integrated cartridge and packaging system is useful for processing of a sample, and in particular for extraction of an analyte of interest from a sample containing the analyte, such as a biological sample. In other embodiments, the sample could be an environmental sample. In either case of sample type, the analyte could be, as described further below, a protein, a nucleic acid, or a cell or cell component.

The integrated cartridge and packaging system is particularly useful for automated extraction, and preferably automated analysis as well, where only minimal operator input is required, when employed in conjunction with an instrument such as described further below. In general, a preferred sample processing device comprises a rigid body having a first side and a second side, and defining at least a first cavity, a second cavity, and a third cavity, wherein the first, second and third cavities are associated with first, second, and third storage packaging members, respectively, each containing a water-miscible liquid reagent in the primary chamber of each packaging member. The cartridge also comprises a first channel, connecting the first cavity and the second cavity, and a second channel region, in fluid communication with and downstream of the second cavity, and connected to the third cavity via a third channel, at a first intersection, wherein the second channel region is associated with a packaging member containing a water-immiscible fluid, a wall member secured to at least a portion of the first side of the rigid body, the wall member disposed over the first cavity, the second cavity, and the third cavity, thereby defining a first chamber, a second chamber, and a third chamber, which may be a lysis chamber, wash chamber, and elution/process chamber, respectively. An inlet port is in direct communication with the first chamber; and a plurality of solid carrier particles is optionally present in the first chamber.

The packaging member containing a water-immiscible fluid preferably contains a volume of fluid that is sufficient, when dispensed to the second channel region from the packaging member, to produce a continuous layer of the water-immiscible fluid within the second channel region that includes the first intersection.

In certain embodiments, the device further comprises a fourth chamber, which may be a further wash chamber, in communication with the second channel region via a second intersection, upstream of the first intersection. This chamber is associated with a fourth packaging member, containing a water-miscible reagent.

In this case, the packaging member containing a water-immiscible fluid preferably contains a volume of said fluid that is sufficient, when dispensed to the second channel region from the storage compartment, to produce a continuous layer of the water-immiscible fluid within the second channel region that includes the first and second intersections.

Preferably, the water-miscible liquid reagent in each of the first, second and third packaging members is selected from an aqueous buffer, a water-containing lysis buffer, a water-based salt solution, and an elution medium. The fourth packaging member may contain an aqueous or aqueous ethanolic solution.

In some embodiments, and depending on the liquid reagent, design of the cartridge and intended use of the cartridge, one or more packaging members may contain a volume of liquid reagent that is greater than the combined volume of the inlet port, inlet conduit, cartridge chamber, and a channel upstream or downstream of the cartridge chamber.

As described in U.S. Patent Application. Publication No. 2009/0246782, which is incorporated herein by reference in its entirety, the “water-immiscible fluid” is a liquid or semisolid fluid that phase-separates when diluted with an equal part of water; preferably, the fluid phase-separates when diluted 2:1, 4:1, or 10:1 with water. More preferably, the water-immiscible fluid is substantially fully immiscible with water; it is preferably immiscible with lower alcohols as well. Examples of suitable water-immiscible fluids include lipophilic fluids such as waxes, preferably liquid waxes such as Chill-Out™ 14 wax (MJ Research), and oils, such as mineral oil, paraffin oil, or silicone, fluorosilicone, or fluorocarbon oils. Semisolid waxes may also be used, as long as the external force applied is sufficient to move the solid phase carrier through the medium; heat may be applied to reduce viscosity. In general, waxes and oils that are liquid at room temperature are preferred. Also suitable are, for example, hydrocarbon solvents such as toluene, hexane, or octane, and polar hydrophobic solvents such as 1,4-dioxane, acetonitrile, tert-butanol or higher (up to about C₁₂) alcohols or acetates, cyclohexanone, or t-butyl methyl ether. If a polar hydrophilic solvent is employed, the water-miscible liquid reagents employed in the device preferably do not include substantial amounts of lower alcohols. Preferably, the water-immiscible fluid has a low vapor pressure and a specific gravity less than that of water. In selected embodiments, the water-immiscible fluid is an oil, such as mineral oil.

In one embodiment, the cartridge contains a plurality of solid carrier particles, and movement of the carrier particles into the water-immiscible fluid serves to further isolate a particle-bound analyte from remaining components of the sample, which tend to remain in a water-miscible aqueous phase within a cartridge chamber.

The integrated cartridge and packaging system when used to isolate and detect an analyte from a sample is used in accord with a specific sequence of fluid movement, to prevent cross-contamination of fluids in the chambers of the cartridge. In one embodiment, a packaging member comprising a lysis reagent in the primary chamber is opened first, to dispense a lysis reagent into a first chamber of the cartridge where a sample for processing is received. Next, packaging members comprising a wash reagent and an elution or processing reagent are opened, to dispense a wash reagent into a second chamber of the cartridge that is downstream from the lysis chamber, and to dispense a processing reagent into a processing or amplification chamber of the cartridge that is downstream from the chamber with the wash reagent. Next, a packaging member comprising a water-immiscible liquid is opened, to dispense from its primary chamber the water-immiscible liquid in the flow path that connects the processing chamber and wash chamber, and optionally, the lysis chamber, of the cartridge.

In some embodiments, cartridge is designed for use in a vertical orientation which facilitates use of gravity for fluid flow and allows for any air bubbles that have entered the cartridge to float up to the top and near or into an overflow chamber.

Accordingly, a method for extraction or isolation of an analyte is contemplated, wherein an integrated cartridge and packaging system, as described above, is provided. With reference to FIGS. 2A-2C, and a sample is introduced into the first chamber 84 via the sample entry port 82 and conduit 86. In one embodiment, a cap 88 on the sample entry port is removed, and sample is introduced into the opening. The cap is replaced and the sample is drawn into the first chamber, for example, by gravity (depending on relative placement of the entry port, conduit and chamber) or by a pulse of air by a piston contained in the cap. In one embodiment, a reagent in dried or lyophilized form is contained in the first chamber, and is solubilized by the liquid sample, and further solubilized by fluid in the storage chamber associated with the first chamber when the fluid is dispensed into the first chamber. After the sample is introduced into the device, the fluid in the packaging member associated with the first chamber is dispensed, by applying a force or pressure to the secondary chamber causing it to open and thus create a fluid connection between the first chamber of the device and the primary chamber of the packaging member. The fluid contents of the primary chamber of the packaging member will flow into the associated (first) chamber. A similar process is repeated for each of the packaging members associated with the cartridge, in a desired sequence.

In a desired embodiment, the volume of fluid in a packaging member associated with a chamber is selected to achieve a desired goal or outcome. For example, in one embodiment, the capacity of the first chamber is larger than the volume of fluid in its associated packaging member, so that fluid in the first chamber does not flow into the channel that connects the first chamber with an adjacent, downstream chamber (for example, channel 92 in FIGS. 2A, 2C). In another embodiment, the volume of fluid in a packaging member associated with a chamber is larger than the capacity of the chamber, so that by design fluid in the storage compartment overfills the associated chamber and flows into a channel or conduit in the fluid flow path of the device. By way of example, in one embodiment, the volume of fluid in the packaging member associated with the processing chamber (such as chamber 110 in FIGS. 2A, 2C) is greater than the capacity of the processing chamber. Fluid in the storage compartment associated with the processing chamber fills to capacity the processing chamber and flows into the conduit upstream of the processing chamber (e.g., conduit 108 in FIGS. 2A, 2C).

After fluid is introduced into each of the chambers in the device, the packaging member filled with the immiscible fluid is opened, to dispense its contents into the device. In the device embodiment of FIGS. 2A-2C, the immiscible fluid flow via port 132 into conduit 136. Fluid in the processing chamber that has overflowed into conduit 108 is displaced by the immiscible fluid and pushed into an overflow chamber, such as the lower portion 102 of chamber 100 in the device of FIGS. 2A, 2C. As can be appreciated, this approach permits precise control over the amount of fluid in the processing chamber. The amount of immiscible fluid in the storage compartment is sufficient flow into the channel of the flow path in the cartridge. For example, the immiscible fluid fills the lower portion 102 of chamber 100, and flows in the channel upstream of chamber 100 (e.g., channel 96 in the device of FIGS. 2A, 2C). Once the immiscible fluid is dispensed, a series of fluid/immiscible fluid interfaces in the device are defined. For example, a first fluid/immiscible fluid interface exists at the junction of processing chamber (110 in FIGS. 2A, 2C) and the channel upstream of the processing chamber (channel 108 in FIGS. 2A, 2C). Another fluid/immiscible fluid interface is created at the junction between wash chamber 94 and the channel leading into the chamber (channel 96 in FIGS. 2A, 2C). In one embodiment, another fluid/immiscible fluid interface is created at the junction between wash chamber 90 and the channel leading into the chamber (channel 111 in FIGS. 2A, 2C). After the fluids are introduced into the device, and when the solid carrier particle/analyte complex(es) is/are moved from the first chamber to downstream subsequent chambers, the fluid/immiscible fluid interfaces remain stationary.

The volume of fluid in the primary chamber and or secondary chamber (collectively the packaging member) is variable, as can be appreciated based on the description herein. Typically, the volume of liquid in the packaging member is in the range of 0.10 mL to 5.0 mL, preferably 0.1-3 mL, or 0.1-2 mL.

The use of the device is not limited to any particular analyte, group of analytes, or sample types. As known in the art, disease can be diagnosed and monitored by detection of nucleic acids and/or proteins associated with disease pathogens, and/or by quantitation of endogenous biological markers. Cell counts and other types of body fluid analysis can also be used to monitor patient health. As noted above, the cartridge device and instrument are expected to be particular useful in geographical areas that have reduced access to technical training and to expensive analytical equipment. In particular, there is an increasing need for low-cost, rapid and reliable diagnosis and monitoring of diseases such as HIV, tuberculosis, and pertussis in the developing world. Accordingly, the cartridge device can be supplied with particles treated to selectively bind to such a nucleic acid or protein, and assay reagents, which may include, for example, labeled antibodies, nucleic acid amplification reagents, and/or labeled probes, can be supplied in one or more process chambers within the device.

The systems and described herein find use in any number of diagnostic assays. Examples include, but are not limited to, PCR medical diagnostics tests (e.g., for infectious diseases such as HIV). In some embodiments, the systems and methods of the present invention find use in performing assays in resource limited areas where temperature controlled environments may not be available. In some embodiments, assays are packaged as self-sufficient, individual tests that will have all the necessary (liquid) reagents on-cartridge to complete the patient's analysis. By further integration with lyophilized assay beads, cold chain technology is avoided, saving on cost and making the test more robust and readily available to a larger public.

The systems and methods of embodiments of the present invention have numerous benefits and applications in any lab-on-a-chip technology where relatively small amounts of liquids must be stored with the test cartridge. Examples of research and diagnostic assays suitable for use with the systems and methods described herein are described below.

Any sample suspected of containing the desired material for purification and/or analysis may be tested using the cartridge and integrated packaging system. In some embodiments, the sample is biological sample. Such a sample may be cells (e.g. cells suspected of being infected with a virus, intact cells (e.g., prokaryotic or eukaryotic cells)), tissue (e.g., biopsy samples), blood, urine, semen, or a fraction thereof (e.g., plasma, serum, urine supernatant, urine cell pellet or prostate cells), which may be obtained from a patient or other source of biological material, e.g., autopsy sample or forensic material.

Prior to contacting the sample with the cartridge and integrated packaging system, the sample may be processed to isolate or enrich the sample for the desired molecules. A variety of techniques that use standard laboratory practices may be used for this purpose, such as, e.g., centrifugation, immunocapture, cell lysis, and nucleic acid target capture.

As can be appreciated from the foregoing, in some embodiments, the packaging system is used to dispense liquid into a channel or a reaction chambers in an assay device such as, for example, a rigid (e.g., plastic disposable), planar cartridge. The packaging system, in one embodiment, is comprised of a first hemispherical chamber or ‘blister’ and a second hemispherical chamber or ‘blister’, the two chambers in fluid communication by a connecting channel or conduit. The chambers are appropriately sized for a desired or necessary liquid volume. The desired volume of liquid is aliquoted into the formed chamber, and a secondary flat laminate with a different sealant material is placed on top and a perimeter seal is made, for example via heat, ultrasonic, radio frequency, or laser welding techniques. The packaging member is aligned with and adhered to a rigid cartridge, which contains an input port for fluid entry and connecting channel to the fluidic chamber. By application of a controlled force on one of the two hemispherical blisters in the packaging system, the blister is caused to open, allowing the liquid in the packaging system to enter the cartridge.

This system for packaging and delivering liquids is designed and developed for any number of diagnostic and clinical uses, although it especially serves point-of-care and resource-limited settings, where refrigeration and cold chain technologies are not consistently available. It enables the medical diagnostic cartridge to be self-sufficient since the appropriate liquid reagents are packaged with the test. The high vapor, oxygen, and UV barrier packaging chambers prevent contamination and evaporation of the stored liquids. The method of opening the packaging member and delivering a liquid to an attached cartridge removes the necessity of additional fluidic components, such as pumps, valves, and precision liquid metering units.

1. A liquid packaging system, comprising:
a primary chamber and a secondary chamber, said primary chamber and secondary chamber in fluidic communication by a channel, wherein the secondary chamber has an upper layer and a lower layer, wherein the lower layer is of a material that opens in response to an applied force that the upper layer is able to withstand, whereupon a fluid in the primary chamber can be dispensed from the packaging system.
   2. The system of embodiment 1, wherein the primary chamber has a larger volume than the secondary chamber.
   3. The system of the separate or combined embodiments 1-2, wherein the upper layer of the secondary chamber is of a material that is more ductile than the material of the lower layer.
   4. The system of the separate or combined embodiments 1-3, wherein the material of the lower layer is a foil.
   5. The system of the separate or combined embodiments 1-4, wherein the material of the upper layer and/or the material of the lower layer is a laminate.
   6. The system of the separate or combined embodiments 1-5, wherein the primary chamber is comprised of an upper layer and a lower layer joined about a perimeter of the chamber other than at a junction of the channel and the primary chamber.
   7. The system of the separate or combined embodiments 1-6, wherein the upper layer and lower layer of the secondary chamber are joined about a perimeter of the chamber other than at a junction of the channel and the primary chamber.
   8. The system of the separate or combined embodiments 1-7, wherein the upper and lower layers are joined to form a seal that is able to withstand the applied force.
   9. The system of the separate or combined embodiments 1-8, wherein the primary chamber contains a liquid.
   10. The system of the separate or combined embodiments 1-9, wherein the secondary chamber contains a liquid.
   11. The system of the separate or combined embodiments 1-10, wherein the liquid in the secondary chamber is the same as the liquid in the primary chamber.
   12. The system of the separate or combined embodiments 1-11, wherein the channel has an upper layer and a lower layer, the channel upper layer and channel lower layers joined together to form a seal other than at a junction of the channel with each of the primary and secondary chambers.
   13. The system of the separate or combined embodiments 1-12, wherein the primary chamber, the channel and the secondary chamber are integrally formed from the same upper layer and lower layer.
   14. The system of the separate or combined embodiments 1-13, wherein the material of the lower layer is less ductile than the material of the upper layer.
   15. A device, comprising:
a planar cartridge comprising a rigid body and a reaction chamber;
a backing member attached to the rigid body, the backing member comprising a liquid packaging member comprised of a primary chamber and a secondary chamber, said primary chamber and secondary chamber in fluidic communication by a channel, wherein the secondary chamber has an upper layer and a lower layer, wherein the lower layer is of a material that tears, breaks or split in response to an applied force that the upper layer is able to withstand, whereupon a fluid in the primary chamber can be dispensed from the packaging member.
   16. The device of embodiment 15, wherein the planar cartridge further comprises an inlet port associated with the reaction chamber, and wherein the secondary chamber of the packaging member is aligned with the inlet port such that when the lower layer opens the fluid is dispensed from the packaging member into the reaction chamber via the inlet port.
   17. The device of the separate or combined embodiments 15-16, wherein the planar cartridge comprises a plurality of reaction chambers, each reaction chamber having an inlet port, and wherein the backing member comprises a plurality of packaging members.
   18. The device of the separate or combined embodiments 15-17, wherein the number of packaging members in the plurality is the same as or exceeds the number of reaction chambers in the planar cartridge.
   19. The device of the separate or combined embodiments 15-18, wherein the primary chamber of the liquid packaging member contains a fluid selected from the group consisting of a water-immiscible liquid and a water-containing solution.
   20. The device of the separate or combined embodiments 15-19, wherein the water-containing solution is selected from the group consisting of a water-alcohol solution, a buffer, a lysis buffer solution, and a water-salt solution.
   21. The device of the separate or combined embodiments 15-20, wherein the water-immiscible liquid is an oil.
   22. The device of the separate or combined embodiments 15-21, further comprising a piercing member positioned within the cartridge, wherein at least one of the piercing member and the secondary chamber are movable with respect to each other such that the piercing member pierces at least a portion of the lower layer of the secondary chamber thereby permitting a fluid in the primary chamber to be dispensed from the packaging member into the cartridge.
   23. The device of the separate or combined embodiments 15-22, further comprising a piercing member positioned at least partially within the inlet port.
   24. The device of the separate or combined embodiments 15-23, further comprising a piercing member positioned at least partially within the reaction chamber.
   25. The device of the separate or combined embodiments 15-24, wherein the piercing member is movable by an applied force between a first position and a second position, and wherein the piercing member contacts at least a portion of the secondary chamber lower layer in the second position.
   26. The device of the separate or combined embodiments 15-25, wherein at least one of the piercing member and the secondary chamber is movable by an externally applied force.
   27. A system, comprising:
a planar cartridge comprising a rigid body, and a piercing member; and
a backing member attached to the rigid body, the backing member comprising a liquid packaging member comprised of a primary chamber and a secondary chamber, said primary chamber and secondary chamber in fluidic communication by a channel, wherein the secondary chamber has an upper layer and a lower layer;
wherein the piercing member and the secondary chamber are movable with respect to each other by an applied force such that the piercing member contacts the lower layer, thereby permitting a fluid in the primary chamber to be dispensed from the packaging member.
   28. The system of embodiment 27, wherein the planar cartridge further comprises an inlet port and a reaction chamber, wherein the inlet port is associated with the reaction chamber, and wherein the secondary chamber of the packaging member is aligned with the inlet port such that when the lower layer opens the fluid is dispensed from the packaging member into the reaction chamber via the inlet port.
   29. The system of the separate or combined embodiments 27-28, wherein the planar cartridge comprises a plurality of reaction chambers, each reaction chamber having an inlet port, and wherein the backing member comprises a plurality of packaging members.
   30. The system of the separate or combined embodiments 27-29, wherein each inlet port includes a piercing member for piercing the lower layer of the associated secondary chamber.
   31. The system of the separate or combined embodiments 27-30, wherein at least one of the piercing member and the secondary chamber is movable by an externally applied force.
   32. The system of the separate or combined embodiments 27-31, wherein the piercing member is selected from a spike or a needle.
   33. The system of the separate or combined embodiments 27-32, wherein the piercing member is a cantilevered spike.
   34. The system of the separate or combined embodiments 27-33, wherein at least a portion of the cantilevered spike is integral with the planar cartridge.
   35. The system of the separate or combined embodiments 27-34, wherein each end of the cantilevered spike is integral with the planar cartridge.
   36. The system of the separate or combined embodiments 27-35, further comprising an actuator for actuating the secondary chamber thereby moving at least a portion of the lower layer of the secondary chamber into contact with the piercing member.
   37. The system of the separate or combined embodiments 27-36, wherein the actuator applies an external force to the secondary chamber.
   38. The system of the separate or combined embodiments 27-37, further comprising an actuator for actuating the piercing member thereby moving the piercing member into contact with at least a portion of the lower layer of the secondary chamber.
   39. The system of the separate or combined embodiments 27-38, wherein the actuator applies an external force to the piercing member.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

It is claimed:

1. A liquid packaging system, comprising:
a primary chamber and a secondary chamber, said primary chamber and secondary chamber in fluidic communication by a channel, wherein the secondary chamber has an upper layer and a lower layer, wherein the lower layer is of a material that opens in response to an applied force that the upper layer is able to withstand, whereupon a fluid in the primary chamber can be dispensed from the packaging system.

2. The system of claim 1, wherein the primary chamber has a larger volume than the secondary chamber.

3. The system of claim 1, wherein the upper layer of the secondary chamber is of a material that is more ductile than the material of the lower layer.

4. The system of claim 3, wherein the material of the lower layer is a foil.

5. The system of claim 3, wherein the material of the upper layer and/or the material of the lower layer is a laminate.

6. The system of claim 1, wherein the primary chamber is comprised of an upper layer and a lower layer joined about a perimeter of the chamber other than at a junction of the channel and the primary chamber.

7. The system of claim 1, wherein the upper layer and lower layer of the secondary chamber are joined about a perimeter of the chamber other than at a junction of the channel and the primary chamber.

8. The system of claim 6, wherein the upper and lower layers are joined to form a seal that is able to withstand the applied force.

9. The system of claim 1, wherein at least one of the primary chamber and the secondary chamber contains a liquid.

10. The system of claim 9, wherein the liquid in the secondary chamber is the same as the liquid in the primary chamber.

11. The system of claim 1, wherein the channel has an upper layer and a lower layer, the channel upper layer and channel lower layers joined together to form a seal other than at a junction of the channel with each of the primary and secondary chambers.

12. The system of claim 1, wherein the primary chamber, the channel and the secondary chamber are integrally formed from the same upper layer and lower layer.

13. The system of claim 12, wherein the material of the lower layer is less ductile than the material of the upper layer.

14. A device, comprising:
a planar cartridge comprising a rigid body and a reaction chamber;
a backing member attached to the rigid body, the backing member comprising a liquid packaging member comprised of a primary chamber and a secondary chamber, said primary chamber and secondary chamber in fluidic communication by a channel, wherein the secondary chamber has an upper layer and a lower layer, wherein the lower layer is of a material that tears, breaks or split in response to an applied force that the upper layer is able to withstand, whereupon a fluid in the primary chamber can be dispensed from the packaging member.

15. The device of claim 14, wherein the planar cartridge further comprises an inlet port associated with the reaction chamber, and wherein the secondary chamber of the packaging member is aligned with the inlet port such that when the lower layer opens the fluid is dispensed from the packaging member into the reaction chamber via the inlet port.

16. The device of claim 14, wherein the planar cartridge comprises a plurality of reaction chambers, each reaction chamber having an inlet port, and wherein the backing member comprises a plurality of packaging members.

17. The device of claim 16, wherein the number of packaging members in the plurality is the same as or exceeds the number of reaction chambers in the planar cartridge.

18. The device of claim 14, wherein the primary chamber of the liquid packaging members contains a fluid selected from the group consisting of a water-immiscible liquid and a water-containing solution.

19. The device of claim 18, wherein the water-containing solution is selected from the group consisting of a water-alcohol solution, a buffer, a lysis buffer solution, and a water-salt solution.

20. The device of claim 18, wherein the water-immiscible liquid is an oil.
